(19) United States
(12) Patent Application Publication
(10) Pub. No.: US 2026/0320840 A1
(43) Pub. Date: Oct. 15, 2026

(54) VIDEO COLOR-ENHANCEMENT USING GENERATIVE NEURAL NETWORKS

(71) Applicant: GDM Holding LLC, Mountain View, CA (US)

(72) Inventors: Danny Karmon, Petah Tikva (IL); Ilia Labzovsky, Tel Aviv-Yafo (IL)

(21) Appl. No.: 19/179,455

(22) Filed: Apr. 15, 2025

(51) Int. Cl. G06T 7/90; G06T 5/60

(52) U.S. Cl. CPC G06T 7/90; G06T 5/60

(57) ABSTRACT

Methods, systems, and apparatus, including computer programs encoded on a computer storage medium, for generating an enhanced video stream using a real-time video color-enhancement system. The method includes applying an initial set of color-enhancing masks to an input video stream to generate an initial enhanced video stream, and providing the initial enhanced video stream to a user on a user device. The method further includes receiving a user input indicating an effectiveness of the initial set of color-enhancing masks and processing a generative input including (i) the user input and (ii) an input specifying the initial set of color-enhancing masks using a generative neural network to generate an updated set of color-enhancing masks. The method includes applying the updated set of color-enhancing masks to the input video stream to generate an updated enhanced video stream and providing the updated enhanced video stream to the user on the user device.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that generates an enhanced video stream by applying one or more color-enhancing masks to an input video stream based on processing a user input using a generative neural network.

In particular, the system can receive the input video stream, and the system can apply an initial set of one or more color-enhancing masks to the input video stream to generate an initial enhanced video stream. As described in this specification, a mask can be an image layer configured to isolate a set of pixels of one or more frames of the input video stream. For example, a color-enhancing mask is configured to isolate a set of pixels of the input video stream by enhancing (e.g., visually highlighting) a color of the set of pixels.

The system can then provide the initial enhanced video stream for presentation to a user on a user device. After presenting the initial enhanced video stream to the user, the system can receive a user input indicating an effectiveness of the initial set of one or more color-enhancing masks. The system can process a generative input that includes (i) the user input and (ii) an input specifying the initial set of one or more color-enhancing masks using a generative neural network to generate an updated set of one or more color-enhancing masks, and the system can then apply the updated set of one or more color-enhancing masks to the initial enhanced video stream to generate an updated enhanced video stream. The system can provide the updated enhanced video stream for presentation to the user on the user device.

In some implementations, the system stores data associated with the one or more color-enhancing masks, where the data includes data specifying the updated set of one or more color-enhancing masks.

In some implementations, the data associated with the one or more color-enhancing masks includes the user input, the input specifying the initial set of one or more color-enhancing masks, or both.

In some implementations, providing the initial enhanced video stream for presentation to a user on a user device includes requesting the user input by displaying a user input request on a user interface of the user device and receiving the user input based on the user providing text via the user interface of the user device.

In some implementations, the text indicates a clarity of the initial enhanced video stream, a contrast of the initial enhanced video stream, a realism of the initial enhanced video stream, or a combination thereof.

In some implementations, processing a generative input including the user input and an input specifying the initial set of one or more color-enhancing masks includes processing at least one frame of the input video stream using the generative neural network to generate a context for the input video stream and processing the generative input and the context for the input video stream to generate the updated set of one or more color-enhancing masks for the input video stream.

In some implementations, processing at least one frame of the input video stream using the generative neural network to generate a context for the input video stream includes processing an initial frame of the initial enhanced video stream using the generative neural network to generate an initial context for the input video stream and processing a subsequent frame of the input video stream using the generative neural network to generate an updated context for the input video stream based on a delta value associated with the initial frame of the input video stream and the subsequent frame of the input video stream.

In some implementations, processing a subsequent frame of the initial enhanced video stream using the generative neural network to generate an updated context for the initial enhanced video stream based on a delta value associated with the initial frame includes determining a delta value between the initial frame of the input video stream and the subsequent frame of the input video stream, comparing the delta value to a threshold value, and prompting the generative neural network to generate the updated context for the input video stream by processing the subsequent frame of the input video stream based on the delta value exceeding the threshold value.

In some implementations, the initial set of one or more color-enhancing masks and the updated set of one or more color-enhancing masks are each represented by code generated by the generative neural network

In some implementations, applying the updated set of one or more color-enhancing masks to the input video stream to generate an updated enhanced video stream includes generating a type of the updated set of color-enhancing masks based on the context of the input video stream, user information, or both.

In some implementations, the method further comprises fine-tuning the generative neural network according to a particular loss function based on a size of the generative neural network.

Particular embodiments of the subject matter described in this specification can be implemented so as to realize one or more of the following advantages.

Enhancing color in videos is particularly useful for improving visual quality across a wide range of applications. For example, video color-enhancement can significantly improve the user experience for color blind individuals when viewing streaming videos or performing real-time tasks, such as controlling a vehicle. By applying these techniques, color blind users can perceive colors more accurately, and in some examples in real-time, resulting in a more accessible and immersive user experience.

Some conventional systems apply a pre-defined mask based on a user's color perception type (e.g., a type of color blindness). However, these techniques may not work well in all situations. For example, red-green color blindness varies in severity, so existing solutions may not effectively enhance colors for a particular user's specific visual requirements. Moreover, these solutions lack user customization, in that they do not consider user feedback as part of the video refinement process. Moreover, most solutions are fixed across video streams, such that these systems are unable to customize for color perception type for each individual video stream.

In contrast, the described system implements a generative neural network to generate customized color-enhancing masks for a user based on user feedback. That is, the system leverages a generative neural network to process user feedback and to adjust the color-enhancing masks for video input in real-time.

In particular, the system can initially apply a set of color-enhancing masks to the video stream to generate an initial enhanced video stream based on a context of the video stream. The context of the video stream can include environmental information, user information, or both. The system can then request user feedback about the effectiveness of the initial enhanced video stream. For example, the user feedback can indicate whether the user can identify the difference between colors of the video stream based on a clarity, a contrast, or a realism of the video stream.

The system can process the user feedback and the color-enhancing masks as a generative input using the generative neural network to generate an updated set of color-enhancing masks. As such, the system leverages the generative neural network's natural reasoning capabilities to customize the color-enhancing masks for the particular user, and the system can then present an updated enhanced video stream for the user in real-time.

Overall, the described techniques allow for personalized video color correction. The system enhances the video by adjusting colors to compensate for the user's specific color perception deficiencies. That is, the system generates the enhanced video output with a goal of presenting colors in a way that is as close as possible to the original video input while accounting for the user's color blindness by maximizing color differentiation for particular pixels within the video.

Additionally, in some examples, the system can process the video stream input in real-time, ensuring minimal latency. Thus, the entire video-enhancement process can occur in real-time, making it suitable for live video applications, streaming services, and augmented reality implementations, allowing for the technology to be seamlessly integrated into various devices, while offering a practical aid for color blind users to engage more fully with videos in real-time.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows a block diagram of an example video color-enhancement system.

FIG. 2 shows a detailed block diagram of an example video color-enhancement system.

FIG. 3 shows a diagram of outputs of the example video color-enhancement system.

FIG. 4 is a flow diagram of an example process for generating an enhanced video stream using the video color-enhancement system.

Like reference numbers and designations in the various drawings indicate like elements.

### DETAILED DESCRIPTION

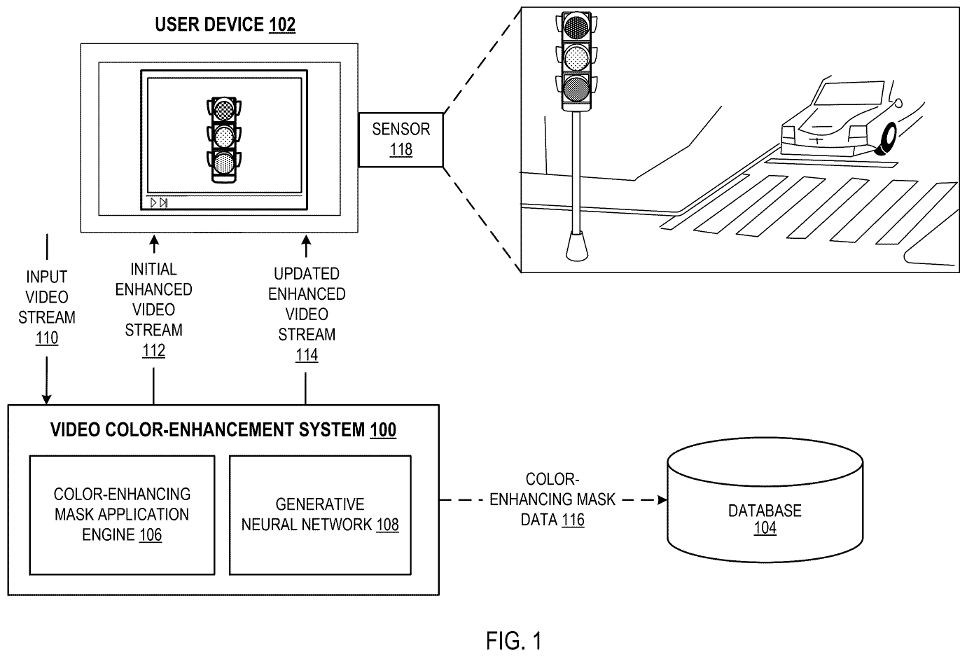

FIG. 1 shows a block diagram of an example video color-enhancement system. The video color-enhancement system 100 is an example of a system implemented as computer programs on one or more computers in one or more locations, in which the systems, components, and techniques described below can be implemented.

The video color-enhancement system 100 is configured to generate an updated enhanced video stream by leveraging a generative neural network to generate the one or more color-enhancing masks for an input video stream.

Generally, systems can apply predefined masks to video for color-enhancement based on a user's color perception type. However, these systems lack precision in that they do not account for variations in color perception (e.g., color blindness severity) or allow user feedback for customization. This lack of customization results in less efficient color differentiation and inconsistent and ineffective user viewing experiences for a variety of individuals.

In contrast, the video color-enhancement system 100 implements a generative neural network to generate customized color-enhancing masks for an input video stream based on user feedback. Additionally, the system 100 can leverage the generative neural network to generate a context for the input video stream, where the customized color-enhancing masks are further based on contextual understanding of the video stream. In some examples, the system 100 can process the input video stream in real-time, allowing for continuous enhancement of the video stream according to the user feedback and the context. By employing these techniques, the system allows for more efficient and more effective video color-enhancement, which allows for an improved user experience with relatively little latency.

The video color-enhancement system 100 is configured to receive an input video stream 110 from an external system, such as a video capturing device, and to provide an updated enhanced video stream 114 to a user device 102. The user device 102 can be a device configured to present a video stream to a user, such as a computer, a smartphone, a tablet, a smart television (TV), and/or augmented reality (AR) glasses. In some examples, the video color-enhancement system 100 can be located on the user device 102. In some other examples, the video color-enhancement system 100 can be located on a remote device.

In some examples, the system 100 can receive the input video stream 110 in real-time from a sensor 118 of the user device 102. The sensor 118 can enable the user device 102 to “see” the environment in the vicinity of the user device 102. In particular, the sensor 118 can be a camera sensor configured to detect reflections of visible light. That is, the camera sensor can capture a video frame at respective different time points. For example, the sensor 118 can be a camera sensor on-board a vehicle that captures a traffic light of an environment, as shown in FIG. 1.

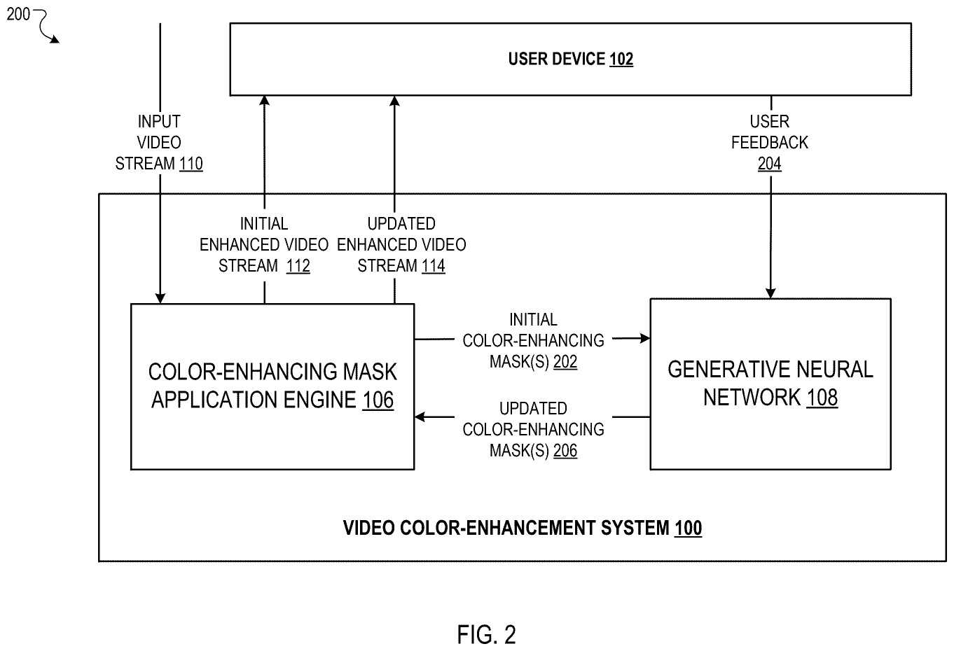

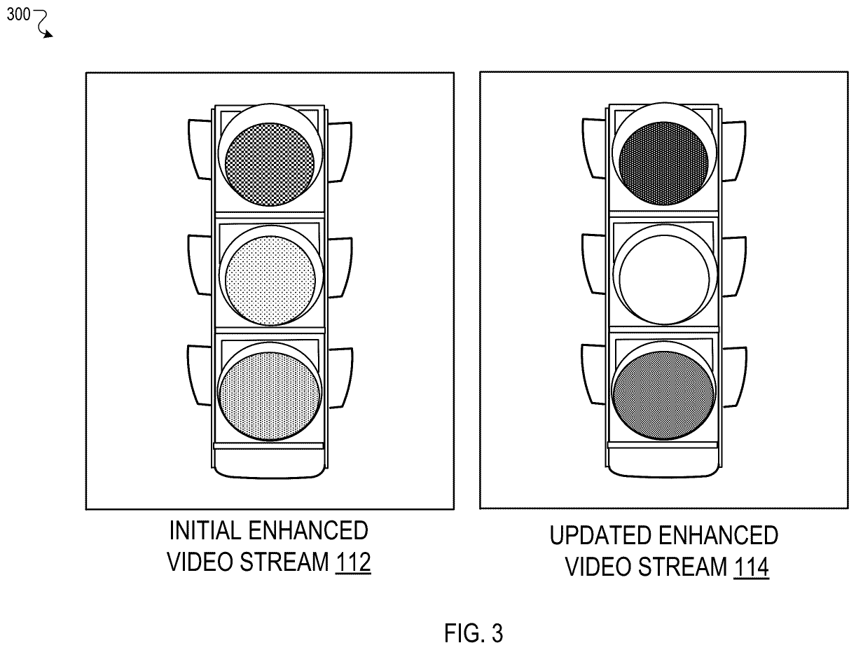

The video color-enhancement system 100 includes a color-enhancing mask application engine 106 configured to apply the one or more color-enhancing masks to the video stream and a generative neural network 108 configured to update the one or more color-enhancing masks based on receiving user feedback. The color-enhancing masks can be represented by code generated by the generative neural network 108, as described in further detail below with reference to FIG. 3. A mask can be a procedure or an image used to control which areas of a video are affected by certain operations or effects. That is, the mask can be an image made up of numerical values that acts as a filter, specifying particular portions of a video frame to enhance, while leaving other portions untouched. The system 100 can apply a mask using generated code that represents the mask by overlaying the mask over the portions of the particular video stream, as described in further detail below with reference to FIG. 2.

In general, the system 100 applies an initial set of color-enhancing masks to the input video stream 110 using the color-enhancing mask application engine 106, and the system 100 generates an updated enhanced video stream 114 by processing user feedback (e.g., user feedback regarding an effectiveness of the initial set of color-enhancing masks) using the generative neural network 108. That is, the system 100 leverages the generative neural network 108 to customize the color-enhancing masks, as described in further detail below with reference to FIGS. 2 and 3.

The generative neural network 108 can be any appropriate type of generative model that can be used to generate a visual output by processing multiple inputs of one or more modalities. For example, the neural network 108 can be a language model neural network that receives an input sequence made up of text tokens selected from a vocabulary and generates, e.g., auto-regressively generates an output sequence from the vocabulary. For example, the neural network 108 can be a Transformer-based language model neural network or a recurrent neural network-based language model. Additionally, or alternatively, the vocabulary of tokens can include tokens that can represent data other than text, such as videos. For example, the vocabulary of tokens can include tokens that represent a discrete set of embeddings of a video that can be generated by an encoder neural network based on processing the embeddings.

In some examples, the neural network 108 can be referred to as an auto-regressive neural network when the neural network used to implement the language model auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

In some cases, the machine learning task is a multi-modal processing task that requires processing multi-modal data. In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

As a particular example, the task is a multi-modal processing task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

More generally, the multi-modal processing task may correspond to any of the tasks previously described for any of the types of data making up the multi-modal combination. For example, an accuracy of the previously described tasks may be increased when the task is applied to multi-modal data combining the data for which the task has been previously described and another type of data. For example detection or classification of an object or event may be improved when data of multiple different types (modalities) is processed. As another example, the quality (e.g., accuracy, fidelity, or intelligibility) of a generated image, video, or audio may be improved when data of multiple different types (modalities) is processed.

Additional description of generative tasks that the neural network (when configured as a “generative” neural network) can perform are discussed below.

Generally, the generative neural network is configured to process a conditioning input (“prompt”) to generate a data item. Generally, the data item represents a response to the conditioning input which may be, e.g., a “prompt” for the generative neural network. For example, the conditioning input can characterize one or more desired properties for the generated data item.

In some implementations the generative neural network generates an output token sequence from an input token sequence including the conditioning input. The generative neural network may then be configured to process the input token sequence to generate for each position in the output token sequence, a respective score for each token in a vocabulary of output tokens, that is used to select an output token for the output token sequence.

In some implementations the tokens can represent text, e.g., words, wordpieces or characters, in a natural or computer language. For example, text may be received, e.g., as a series of encoded characters, e.g., UTF-8 encoded characters; such “characters” can include Chinese and other similar characters, as well as logograms, syllabograms and the like. A text encoder, i.e., a tokenizer, can process a sequence of text to represent the text as a series of text tokens from a vocabulary of text tokens, e.g., that each represent words, wordpieces or characters in a natural or computer language. The computer language may be any formal language used to communicate with a computer, e.g., a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens may be converted into audio data that represent speech corresponding to the text.

Also, or instead the tokens may represent a video. For example, a set (sequence) of input or output tokens can represent a video. Each video token may comprise a block encoding of values of the pixels in a different region of an image that maps a set of values of the pixels to a respective video token. The block encoder may comprise a neural network, e.g., having one or more (self-)attention layers, such as a Transformer neural network.

Also, or instead the tokens may represent an audio waveform. For example, a set (sequence) of input or output tokens can represent audio data representing a waveform, e.g., instantaneous audio amplitude values or time-frequency audio data. Each image token may comprise a block encoding of the audio waveform in a different time segment of the audio that maps a set of values representing the audio waveform to a respective image token. The block encoder may comprise a neural network, e.g., having one or more (self-)attention layers, such as a Transformer neural network.

In some implementations the generative neural network can be a multimodal network that is configured to process a conditioning input comprising one or more of text data, audio data defining an audio signal (e.g., as amplitude values of the audio signal or as a time-frequency representation of the audio signal), or a still or moving image (e.g., as image pixel values), to generate a data item that can similarly comprise text data, audio data, or a still or moving image.

For example, the conditioning input may comprise text and the data item may comprise an image or an audio signal that represents speech an image generated in response to the text, e.g., described by the text. Also, or instead the conditioning input may comprise an audio signal that represents speech, or an image, and the data item may comprise text, e.g., that describes the conditioning input.

In some implementations, the neural network 108 is pre-trained, i.e., trained on a language modeling task, and the system 100 causes the neural network 108 to generate output sequences through natural language prompts in the input sequence. For example, the system 100, or a separate training system, pre-trains the neural network 108 on a language modeling task, e.g., a task that requires predicting, given a current sequence of text tokens, the next token that follows the current sequence in the training data. As a particular example, the neural network 108 can be pre-trained on a maximum-likelihood objective on a large dataset of text, e.g., text that is publicly available from the Internet or another text corpus.

In some examples, the system 100 can fine-tune the generative neural network 108. For example, in the case where the generative neural network 108 is located on the user device 102, the generative neural network 108 can be a relatively small neural network (e.g., a neural network with a relatively small amount of parameters). The system 100 can fine-tune the generative neural network to improve the multimodal reasoning capabilities of the model. That is, the system 100 can fine-tune the generative neural network 108 on an objective that minimizes error against expert-defined masks and/or maximizes predicted user satisfaction (e.g., via reinforcement learning from human feedback(RLHF)). In the case that the system fine-tunes the neural network to minimize error against expert-defined masks, fine-tuning involves updating model weights using examples that include the input context, feedback, and the initial mask paired with desired output masks. In the case that the system fine-tunes using reinforcement learning, the system can use a reward model to score updated masks generated by the neural network, and use the resulting reward scores as rewards for the reinforcement learning training.

In particular, the system 100 applies an initial set of color-enhancing masks using the color-enhancing mask application engine 106 to generate an initial enhanced video stream 112. In some examples, the system 100 can generate an initial context for the input video stream 110, and the system can generate the initial set of color-enhancing masks based on the initial context, as described in further detail below with reference to FIG. 2.

The system 100 then provides the initial enhanced video stream 112 to the user device 102. The user of the user device 102 can view the initial enhanced video stream 112, and the user can provide user feedback based on the initial enhanced video stream 112. In particular, the system can present the initial enhanced video stream 112 with a user interface that allows the user to provide the feedback while the user is viewing the initial enhanced video stream 112. That is, the user feedback can indicate an effectiveness in enhancing a clarity of the video, a color contrast of the video, or a realism of the video, as described in further detail below with reference to FIGS. 2 and 3.

The system 100 can receive the user feedback, and the system 100 can generate an updated set of customized color-enhancing masks based on processing the user feedback using the generative neural network 108. In some examples, the system 100 can generate an updated context for the input video stream 110, and the system 100 can further process the updated context using the generative neural network 108 to generate the updated set of color-enhancing masks, as described in further detail below with reference to FIG. 2. The system 100 can then apply the updated set of customized color-enhancing masks to the initial enhanced video stream 112 to generate the updated enhanced video stream 114. The system 100 can then provide the updated enhanced video stream 114 for presentation to the user. That is, the system 100 can repeatedly apply the updated set of customized color-enhancing masks while the user is viewing the video, such that the system 100 adjusts the presented video stream in real-time to account for the user preference, changing video content, environmental conditions, or a combination thereof.

In some examples, the system can provide color-enhancing mask data 116 to a database 104 for storage. The color-enhancing mask data 116 can include data representing the updated color-enhancing masks. In some examples, the system can also provide the user feedback, the initial set of color-enhancing masks, or both to the database 104 for storage. That is, the system can retrieve the color-enhancing mask data 116 to enhance subsequent input video streams. In this way, the system 100 can apply the customized color-enhancing masks for the particular user to future input video streams of the system 100 before the streams are provided to the user.

FIG. 2 shows a detailed block diagram of an example video color-enhancement system 100.

The video color-enhancement system 100 is configured to process the input video stream 110 to generate the updated enhanced video stream 114 by generating and applying one or more color-enhancing masks. The video color-enhancement system 100 includes the color-enhancing mask application engine 106 configured to apply the one or more color-enhancing masks and the generative neural network 108 configured to generate the one or more color-enhancing masks.

The one or more color-enhancing masks can be represented as code or structured data (e.g., JSON) defining one or more parameters. For example, the one or more parameters can include color shifts, contrast values, highlighting pattern types, or highlighting target regions.

One or more parameters corresponding to a color shift can indicate a change (e.g., an edit) to the colors of the input video stream 110 to increase differentiation. For example, the color-enhancing mask can indicate an update to the parameter corresponding to a color shift that changes the color red to purple. One or more parameters corresponding to a contrast value can indicate an increase to a contrast between one or more colors of the input video stream 110. For example, the color-enhancing mask can indicate an update to the parameter corresponding to a contrast value of one or more colors that increases the contrast from a first color (e.g., green) and a second color (e.g., red). One or more parameters corresponding to a pattern type can indicate an accentuation of a pattern type. For example, in the case of a driver who is color-blind, it may be particularly advantageous to highlight a pattern type on the road, such as a road marking, to increase safety while driving. One or more parameters corresponding to a target region can indicate an accentuation of a particular target region of a frame of the input video stream 110. For example, as described above in the case of a driver who is color-blind, it may increase driving safety to highlight certain portions of the road and/or traffic signs.

In some examples, the one or more color-enhancing masks can be device specific. That is, the system can generate the one or more color-enhancing masks based on a parameter specific to the device (e.g., a type of device, a location of a device, or both).

For example, a user may initially use a first device (e.g., a mobile device or a computer monitor), which has a set of default color-enhancing masks based on a variety of device-specific parameters, such as screensize, color profile, or brightness range. The user may then switch a second device (e.g., a new computer monitor or a new mobile device). In this case, the system can apply the same default color-enhancing masks associated with the user, ensuring consistency across devices. However, because the second device may have different device-specific parameters (e.g., a different color presentation, different brightness range, or a different lighting environment) the user can provide feedback to the system such that the system can update (e.g., adjust) the one or more color-enhancing masks for the particular computer monitor according to the feedback.

In another example, such as for a camera sensor located outdoors, the system can generate one or more color-enhancing masks based on adjusting (e.g., minimizing) a glare of the camera sensor due to exposure to sunlight.

In particular, the system 100 can receive the input video stream 110 from the user device 102, and the system 100 can apply an initial set of color-enhancing masks (e.g., initial color-enhancing masks 202) to the input video stream 110 to generate an initial enhanced video stream 112. That is, the system 100 can apply the initial color-enhancing masks 202 to the input video stream 110 by overlaying (e.g., superimposing) the mask over the input video stream based on the represented code or structured data by applying a change of one or more parameters, such as a color shift, a contrast, a pattern, highlighting a target region, or a combination thereof.

In some examples, the system 100 can retrieve the initial color-enhancing masks 202 from the database 104 based on prior application of the initial color-enhancing masks 202. In some other examples, the system 100 can generate the initial color-enhancing masks 202 by processing contextual information associated with the input video stream 110 using the generative neural network 108, as described in further detail below.

The system 100 can then provide the initial enhanced video stream 112 to the user device 102, and the user device 102 can present the initial enhanced video stream 112 to a user of the user device 102 in real-time. In particular, the user device 102 can play the initial enhanced video stream 112 in real-time, and, optionally, a user interface of the user device 102 can request the user to provide user feedback 204 by displaying a user input request. For example, the user input request can be a query about the effectiveness of the initial color-enhancing masks 202 (e.g., “How is the visual quality of the video?” or “Is there a high level of color differentiation within the video?”).

The user can then provide text or audio representing the user feedback 204 via the user interface of the user device 102. For example, if the user determines that the initial color-enhancing masks 202 are relatively ineffective, the user can provide user feedback 204 that indicates user-specific adjustments. For example, the user feedback can indicate adjustments for increased realism (“Make the video more realistic”), increased contrast (“Add more contrast to the colors”), increased clarity (“Make the video clearer”), or a combination thereof.

In particular, the system 100 can process a generative input using the generative neural network 108 to generate updated color-enhancing masks 206. The generative input includes the user feedback 204 and an input that represents the initial color-enhancing masks 202. That is, the system 100 has the capability to customize the color-enhancing masks in real-time by receiving user feedback regarding a variety of color-enhancement factors.

In some examples, the system 100 can process the generative input and a context of the input video stream 110 to generate the updated color-enhancing masks 206. That is, the system 100 can leverage both the user feedback and contextual information to customize the color-enhancing masks 206. The contextual information can include environmental information, user information, or both. The environmental information can indicate a type of location of the environment, a brightness of the environment, and/or an urgency of the environment (e.g., whether processing the video stream is time-sensitive (e.g., urgent) for the user to perform a particular action, such as controlling a vehicle), as described in further detail below with reference to FIG. 3. The user information can indicate a color perception type of the user (e.g., red-green color blindness), a severity of the color perception type, or both.

In some examples, the system 100 can receive the contextual information (e.g., a context) from the user device 102. In some other examples, the system 100 can generate the context by processing the input video stream 110 using the generative neural network 108. Importantly, the system 100 can leverage chain-of-thought reasoning capabilities of the generative neural network 108, such as a language model, to specifically generate the environmental information of the context. That is, the generative neural network 108 can efficiently determine the context of the input video stream 110 to generate the initial color-enhancing masks 202 because, unlike traditional computer vision algorithms, the generative neural network 108 can apply higher-level reasoning to interpret complex situations beyond mere visual recognition.

In some examples, the system 100 can generate the context for the input video stream 110 in real-time. In particular, the system 100 can process at least one frame of the input video stream 110 using the generative neural network 208 to generate environmental information of the context for the input video stream. In some examples, the system 100 can process at least one frame of the input video stream 110 using another generative neural network to generate environmental information of the context for the input video stream. For example, the system 100 can process an initial frame of the input video stream 110 using the generative neural network to generate an initial context, and the system 100 can process a subsequent frame of the input video stream 110 to generate an updated context for the input video stream 110 based on determining a delta value.

In particular, the delta value represents a difference between the initial frame and the subsequent frame. The system can determine the delta value between the initial frame and the subsequent frame, and the system can compare the delta value to a threshold value. That is, if the difference between the frames is relatively large, the system 100 can determine that the initial context is not particularly relevant (e.g., a situation of the environment has changed), and the system 100 can determine to generate an updated context.

In particular, based on the delta value exceeding the threshold value, the system can prompt the generative neural network to generate an updated context for the input video stream. For example, the system 100 can provide a prompt to the generative neural network 108 requesting for the generative neural network 108 to generate the updated context by processing the subsequent frame of the input video stream 110.

In the case where the delta value does not exceed the threshold value, the system can refrain from prompting the generative neural network, and thus, the system 100 can reduce overall latency in processing the input video stream 110 in real-time, as the system 100 does not need to generate a context for each frame of the input video stream 110.

The system 100 can then process the context and the generative input using the generative neural network 108 to generate the updated set of color-enhancing masks 206. In some examples, the system 100 can provide a prompt to the generative neural network 108 indicating the context (e.g., the initial context, the updated context, or both), the generative input, and a task. For example, the task can be for the generative neural network 108 to output code representing color-enhancing masks that increase color differentiation in the input video stream 110, as described in further detail below with reference to FIG. 3.

The system 100 can then apply the updated color-enhancing masks 206 to the initial enhanced video stream 112 using the color-enhancing mask application engine 106 to generate the updated enhanced video stream 114. The system 100 can provide the updated enhanced video stream 114 to the user device 102 for presentation to the user.

FIG. 3 shows a diagram of outputs of the example video color-enhancement system 100.

The video color-enhancement system 100 can receive the input video stream 110, and the system 100 can process the input video stream 110 to generate the initial enhanced video stream 112 by applying the initial color-enhancing masks 202. The initial color-enhancing masks 202 are represented by code generated by the generative neural network. In some examples, the system 100 can generate a type of the updated set of color-enhancing masks based on the context of the input video stream, user information, or both.

For example, the code can represent a mask that increases color contrast (e.g., a mask that causes green to appear more yellow and red to appear more purple). In another example, the code can represent text indicating a color (e.g., “red”). In another example, the code can represent a mask presenting particular colors as patterns to represent particular colors (e.g., dots for red and lines for green). For example, the code can include: {“mask_type”: “pattern_overlay”, “rules”: [{“color_target”: {“hue_range”: [0, 15], “sat_min”: 0.6, “lum_min”: 0.4}, “pattern”: {“type”: “dots”, “color”: “white”, “density”: 5}}, {“color_target”: {“hue_range”: [100, 140], “sat_min”: 0.6, “lum_min”: 0.4}, “pattern”: {“type”: “h_lines”, “color”: “yellow”, “spacing”: 4}}]}

In this example, the initial enhanced video stream 112 can be a traffic light in an environment. As illustrated in FIG. 3, the colors in the initial enhanced video stream 112 can have a relatively low level of differentiation (e.g., weak color contrast), making it difficult for a color blind user to distinguish between the colors. This lack of clarity could prevent the user from correctly identifying whether the traffic light is green or red, potentially leading to dangerous situations while driving or performing other tasks.

Advantageously, the user can provide feedback in real-time of the effectiveness of the color differentiation of the initial enhanced video stream 112. For example, the user can submit text such as “The color contrast is poor, increase the contrast.” The system 100 can then process the user feedback 204 using the generative neural network 108 to generate updated color-enhancing masks 206 for the video stream by modifying the code representing the color-enhancing mask.

The system can generate an appropriate type of updated color-enhancing mask based on the context of the input video stream, user information, or both. In particular, in the example of FIG. 3, the system 100 can determine to further enhance the color differentiation given the context of the input video stream 110. That is, the system 100 can generate a type of color-enhancing mask that increases the color contrast based on the context and the user information. In a particularly urgent situation in an environment, such as distinguishing traffic signals, the system 100 can prioritize the context of the input video stream by causing the color contrast to be highly pronounced in order to maximize clarity and prevent user misinterpretation. In some other examples, such as watching a movie, the system 100 can generate the appropriate type of updated color-enhancing mask by prioritizing user information, such as particular user preferences. For example, a user may prefer for the color-enhancing mask to represent colors as distinct patterns.

As such, the described techniques allow for increased customization capabilities by leveraging the generative neural network 108 to generate the updated color-enhancing masks 206. That is, the system 100 can consider both user information (e.g., user preferences and/or user feedback) and context in performing video color-enhancement, allowing for system 100 to dynamically determine how best to enhance the video and ensure improved perception of the video for a particular user.

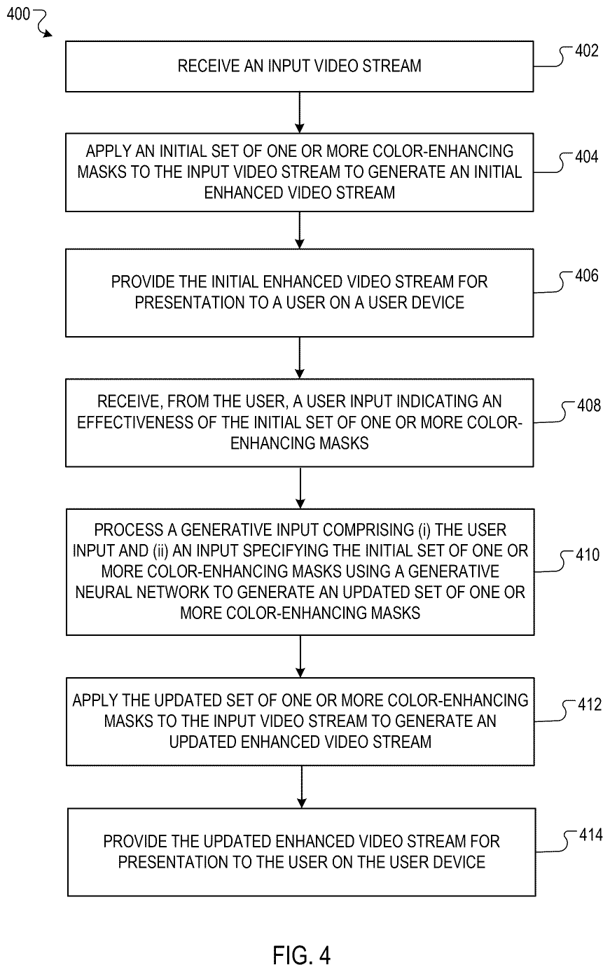

FIG. 4 is a flow diagram of an example process for generating an enhanced video stream using the video color-enhancement system. For convenience, the process 400 will be described as being performed by a system of one or more computers located in one or more locations. For example, a visual input reconstruction system or a visual input processing system, e.g., the video color-enhancement system 100 of FIGS. 1 and 2, appropriately programmed, can perform the process 400.

The system can receive an input video stream (402). The input video stream can be a real-time video stream captured by a camera sensor of a user device.

The system can apply an initial set of the one or more color-enhancing masks to the input video stream to generate an initial enhanced video stream (404).

The system can provide the initial enhanced video stream for representation to a user on the user device (406). In particular, the system can request for the user to provide the user input by displaying a user input request on a user interface of the user device, and the system can receive the user input based on the user providing text via the user interface of the user device. The text can indicate a clarity of the initial enhanced video stream, a realism of the initial enhanced video stream, or both.

The system can receive, from the user, a user input indicating an effectiveness of the initial set of one or more color-enhancing masks (408).

The system can process a generative input including (i) the user input and (ii) an input specifying the initial set of one or more color-enhancing masks using a generative neural network to generate an updated set of one or more color-enhancing masks (410).

In some examples, the system can generate the updated set of one or more color-enhancing masks by processing the generative input and a context of the input video stream. In particular, the system can process at least one frame of the input video stream using the generative neural network to generate a context for the input video stream. For example, the system can process an initial frame of the initial enhanced video stream using the generative neural network to generate an initial context for the input video stream, and the system can process a subsequent frame of the input video stream to generate an updated context for the input video stream based on a delta value. The delta value represents a difference between the initial frame and the subsequent frame. That is, the system can determine the delta value between the initial frame and the subsequent frame, and the system can compare the delta value to a threshold value. Based on the delta value exceeding the threshold value, the system can prompt the generative neural network to generate an updated context for the input video stream. As such, the system can process both the generative input and the updated context using the generative neural network to generate the updated set of one or more color-enhancing masks.

In particular, the prompt to the generative neural network can include text indicating one or more instructions describing the task (e.g., “Generate mask code”) and the desired output format (e.g., “Output JSON mask parameters” or “Generate Python code using library X”). In some examples, the prompt can include one or more few-shot examples (e.g., input/output pairs) to guide the generative neural network to generate correctly formatted and effective code.

The system can apply the updated set of one or more color-enhancing masks to the input video stream to generate an updated enhanced video stream (412). In some examples, the system can generate a type of the updated set of color-enhancing masks based on the context of the input video stream, user information, or both.

The system can provide the updated enhanced video stream for presentation to the user on the user device (414).

In some examples, the system can store data associated with the one or more color-enhancing masks that specifies the updated set of one or more color-enhancing masks. For example, the system can store data associated with the one or more color-enhancing masks, and the system can retrieve the data to apply the updated set of one or more color-enhancing masks to subsequently received input video streams. In some examples, the data can also include (i) the user input, (ii) the input specifying the initial set of one or more color-enhancing masks, or both.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving an input video stream;
applying an initial set of one or more color-enhancing masks to the input video stream to generate an initial enhanced video stream;
providing the initial enhanced video stream for presentation to a user on a user device;
receiving, from the user, a user input indicating an effectiveness of the initial set of one or more color-enhancing masks;
processing a generative input comprising (i) the user input and (ii) an input specifying the initial set of one or more color-enhancing masks using a generative neural network to generate an updated set of one or more color-enhancing masks;
applying the updated set of one or more color-enhancing masks to the input video stream to generate an updated enhanced video stream; and
providing the updated enhanced video stream for presentation to the user on the user device.

2. The method of claim 1, further comprising:
storing data associated with the one or more color-enhancing masks, wherein the data comprises data specifying the updated set of one or more color-enhancing masks.

3. The method of claim 2, wherein the data associated with the one or more color-enhancing masks further comprises: (i) the user input, (ii) the input specifying the initial set of one or more color-enhancing masks, or both.

4. The method of claim 1, wherein providing the initial enhanced video stream for presentation to a user on a user device further comprises:
requesting the user input by displaying a user input request on a user interface of the user device; and
receiving the user input based on the user providing text via the user interface of the user device.

5. The method of claim 4, wherein the text indicates a clarity of the initial enhanced video stream, a contrast of the initial enhanced video stream, a realism of the initial enhanced video stream, or a combination thereof.

6. The method of claim 1, processing a generative input comprising (i) the user input and (ii) an input specifying the initial set of one or more color-enhancing masks using a generative neural network to generate an updated set of one or more color-enhancing masks comprises:
processing at least one frame of the input video stream using the generative neural network to generate a context for the input video stream; and
processing the generative input and the context for the input video stream to generate the updated set of one or more color-enhancing masks for the input video stream.

7. The method of claim 6, wherein processing at least one frame of the input video stream using the generative neural network to generate a context for the input video stream comprises:
processing an initial frame of the initial enhanced video stream using the generative neural network to generate an initial context for the input video stream; and
processing a subsequent frame of the input video stream using the generative neural network to generate an updated context for the input video stream based on a delta value associated with the initial frame of the input video stream and the subsequent frame of the input video stream.

8. The method of claim 7, wherein processing a subsequent frame of the initial enhanced video stream using the generative neural network to generate an updated context for the initial enhanced video stream based on a delta value associated with the initial frame of the input video stream and the subsequent frame of the input video stream comprises:
determining a delta value between the initial frame of the input video stream and the subsequent frame of the input video stream;
comparing the delta value to a threshold value; and
prompting the generative neural network to generate the updated context for the input video stream by processing the subsequent frame of the input video stream based on the delta value exceeding the threshold value.

9. The method of claim 7, wherein the initial set of one or more color-enhancing masks and the updated set of one or more color-enhancing masks are each represented by code generated by the generative neural network.

10. The method of claim 9, wherein applying the updated set of one or more color-enhancing masks to the input video stream to generate an updated enhanced video stream comprises:
generating a type of the updated set of color-enhancing masks based on the context of the input video stream, user information, or both.

11. The method of claim 1, further comprising:
fine-tuning the generative neural network according to a particular loss function based on a size of the generative neural network.

12. A system comprising one or more computers and one or more storage devices storing instructions that are operable, when executed by the one or more computers, to cause the one or more computers to perform operations comprising:
receiving an input video stream;
applying an initial set of one or more color-enhancing masks to the input video stream to generate an initial enhanced video stream;
providing the initial enhanced video stream for presentation to a user on a user device;
receiving, from the user, a user input indicating an effectiveness of the initial set of one or more color-enhancing masks;
processing a generative input comprising (i) the user input and (ii) an input specifying the initial set of one or more color-enhancing masks using a generative neural network to generate an updated set of one or more color-enhancing masks;
applying the updated set of one or more color-enhancing masks to the input video stream to generate an updated enhanced video stream; and
providing the updated enhanced video stream for presentation to the user on the user device.

13. The system of claim 12, further comprising:
storing data associated with the one or more color-enhancing masks, wherein the data comprises data specifying the updated set of one or more color-enhancing masks.

14. The system of claim 13, wherein the data associated with the one or more color-enhancing masks further comprises: (i) the user input, (ii) the input specifying the initial set of one or more color-enhancing masks, or both.

15. The system of claim 12, wherein providing the initial enhanced video stream for presentation to a user on a user device further comprises:
requesting the user input by displaying a user input request on a user interface of the user device; and
receiving the user input based on the user providing text via the user interface of the user device.

16. The system of claim 15, wherein the text indicates a clarity of the initial enhanced video stream, a contrast of the initial enhanced video stream, a realism of the initial enhanced video stream, or a combination thereof.

17. One or more non-transitory storage media storing instructions that when executed by one or more computers cause the one or more computers to perform operations comprising:
receiving an input video stream;
applying an initial set of one or more color-enhancing masks to the input video stream to generate an initial enhanced video stream;
providing the initial enhanced video stream for presentation to a user on a user device;
receiving, from the user, a user input indicating an effectiveness of the initial set of one or more color-enhancing masks;
processing a generative input comprising (i) the user input and (ii) an input specifying the initial set of one or more color-enhancing masks using a generative neural network to generate an updated set of one or more color-enhancing masks;
applying the updated set of one or more color-enhancing masks to the input video stream to generate an updated enhanced video stream; and
providing the updated enhanced video stream for presentation to the user on the user device.

18. The one or more non-transitory storage media of claim 17, further comprising:
storing data associated with the one or more color-enhancing masks, wherein the data comprises data specifying the updated set of one or more color-enhancing masks.

19. The one or more non-transitory storage media of claim 18, wherein the data associated with the one or more color-enhancing masks further comprises: (i) the user input, (ii) the input specifying the initial set of one or more color-enhancing masks, or both.

20. The one or more non-transitory storage media of claim 17, wherein providing the initial enhanced video stream for presentation to a user on a user device further comprises:
requesting the user input by displaying a user input request on a user interface of the user device; and
receiving the user input based on the user providing text via the user interface of the user device.
